(19) United States
(12) Patent Application Publication
(10) Pub. No.: US 2012/0326875 A1
(43) Pub. Date: Dec. 27, 2012

(54) INVISIBLE FENCE FOR A CHILD

(76) Inventor: Deborah Coppola, West Des Moines, IA (US)

(21) Appl. No.: 13/169,775

(22) Filed: Jun. 27, 2011

(51) Int. Cl. G08B 23/00

(52) U.S. Cl. 340/573.4

(57) ABSTRACT

A system and method for alerting a parent or guardian when a child has crossed a threshold of a room or other area is provided. The system includes positioning an alarm module at a desired threshold, with the alarm module creating an invisible plane at a selected angle. A transmitting module is place on a child. The transmitting device emits a signal, such as an RFID signal, that can be read by the alarm module if the transmitter crosses through the plane. Once the signal is read, an alarm is set off to emit a noise that will alert the parent or guardian that the child has passed through the predetermined threshold and that the parent or guardian should check to see where the child has gone.

### FIELD OF THE INVENTION

The present invention generally relates to a child location alerting system. More particularly, but not exclusively, the present invention relates to a child location system to detect when or if a child leaves and/or enters a room.

### BACKGROUND OF THE INVENTION

The background of the invention is discussed in the context of a child location alerting system. The present invention is not to be limited to this specific context. Child location devices are presently available such as Giggle Bug and Mommy I'm Here. Both devices work on the same principle as a cordless phone handset finder or television remote control finder. A location device is clipped or attached to a child's clothing, and if the child becomes lost the parent or guardian can press a button on a handheld unit to cause the device on the child to emit a loud alarm. These devices only work when the parent or guardian notices that the child is missing, at which point they press the alarm button on their handheld unit to alert them to where the child is. If the child is out of range the locator will not alarm.

What is needed is an apparatus and method for a child location alerting system having the advantage of alerting a parent or guardian that their child has left a certain area in real time.

### BRIEF SUMMARY OF THE INVENTION

Therefore, it is a primary, object, feature, or advantage of the present invention to improve over the state of the art.

It is a further object, feature, or advantage of the present invention to provide an apparatus and method for alerting a person when a child has entered or left a room or area.

Another object, feature, or advantage of the present invention is to provide an apparatus and method for monitoring the location of a child that immediately alerts when a child has crossed a threshold.

It is still a further object, feature, and/or advantage of the present invention to provide an apparatus and method for providing an invisible fence or barrier that will set off an alert when a child having a module attached thereto crosses the invisible fence or barrier as set up by a parent.

One or more of these and/or other objects, features, or advantages of the present invention will become clear from the specification and claims that follow. No single embodiment need exhibit each and every object, feature, or advantage.

According to one aspect of the present invention, a buzzer system for creating an invisible fence for knowing when a child has crossed a threshold is provided. The buzzer system includes a transmitting module positioned on the child, the transmitting module emitting a signal. An alarm module is affixed to a surface, with the alarm module configured read the signal of the transmitting module. The alarm module is also adapted to emit a noise when the child has crossed the threshold.

According to another aspect of the present invention a buzzer system for creating an invisible fence for allowing a guardian to know when a child has crossed a threshold even when the child is out of sight is provided. The system includes a transmitting module positioned at the child, the transmitting module comprising a circuit configured to emit a signal. At least one alarm module is affixed to a surface, with the at least one alarm module comprising a reader circuitry for reading the signal and an alarm operatively connected to the reader circuitry. The at least one alarm module is configured to emit a noise from the alarm when the reader circuitry has read the signal from the transmitting module on the child.

According to another aspect of the present invention, a method of using a method of alerting a parent or guardian that a child has crossed a threshold of a room or area is provided. The method includes creating a threshold by affixing an alarm module to a surface with the alarm module emitting a signal reading plane therefrom. A transmitting module is positioned on a child, and the transmitting module emits a signal. Finally, a noise is emitted from the alarm module if the transmitting module crosses the threshold created by the plane, the noise alerting the parent or guardian that the child has crossed the threshold.

### BRIEF DESCRIPTION OF THE DRAWINGS

FIG. 1 is an illustration of the child alerting location system.

FIGS. 2A and 2B are an illustration of the child alerting location system in practice.

FIG. 3 is a schematic of the radio frequency identification (RFID) system used with the present invention.

### DETAILED DESCRIPTION OF THE PREFERRED EMBODIMENT

Radio frequency identification (RFID) is a technology that uses communication via radio waves to exchange data between a reader and an electronic tag attached to an object for the purpose of identification and tracking Specifically, RFID uses a short-range radio technology to communicate mainly digital information between a stationary location and a movable object or between movable objects. An RFID system generally consists of simple devices called tags and more complex devices called readers. RFID tags are small and inexpensive and can be deployed economically in very large numbers. RFID tags usually carry a unique identity and can be attached to the objects to be managed. Most RFID tags contain at least two parts: one is an integrated circuit for storing and processing information, modulating and demodulating a radio-frequency (RF) signal, and other specialized functions; the other is an antenna for receiving and transmitting the signal. One example of such a tag is a Parallax 125 KHz RFID Tag-Key Fob, product number RB-Plx-215, which may be purchased from Parallax Inc., 599 Menlo Drive, Rocklin, Calif. 95765.

RFID readers employ tag-reading algorithms that are capable of identifying tags by the unique identities. Depending on mobility, RFID readers are classified into two different types: fixed RFID and mobile RFID. If the reader reads tags in a stationary position, it is called fixed RFID. These fixed readers are set up specific interrogation zones and create a “bubble” of RF energy that can be tightly controlled if the physics is well engineered. This allows a very definitive reading area for when tags go in and out of the interrogation zone. On the other hand, if the reader is mobile when the reader reads tags, it is called mobile RFID. The RFID reader of the present invention is preferably a fixed reader. One example of an RFID reader that may be used with the present invention is Parallax RFID Card Reader (USB), product number RB-Plx-130, which may be purchased from Parallax Inc., 599 Menlo Drive, Rocklin, Calif. 95765.

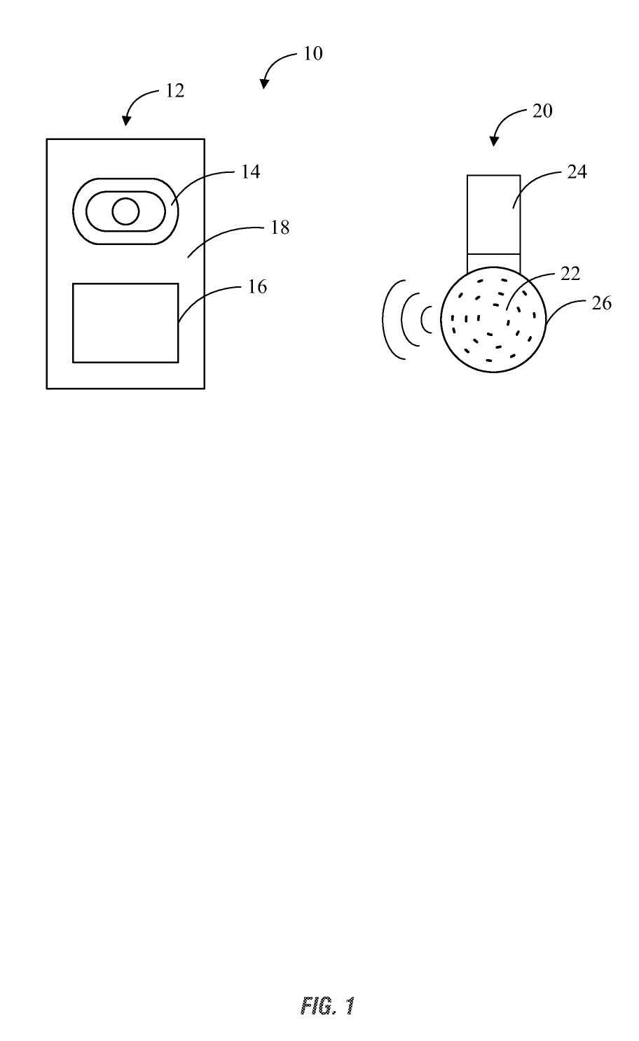

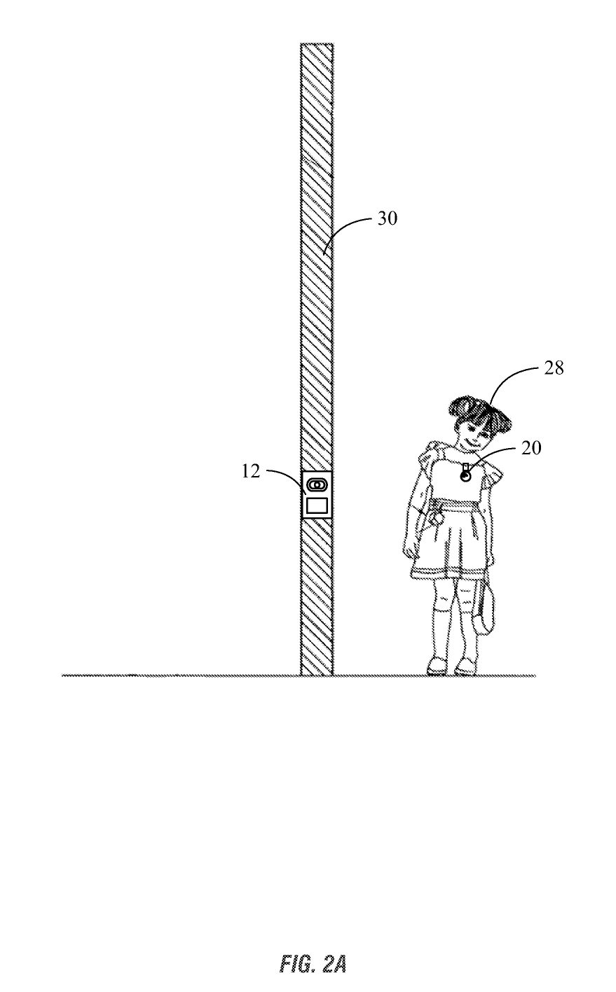

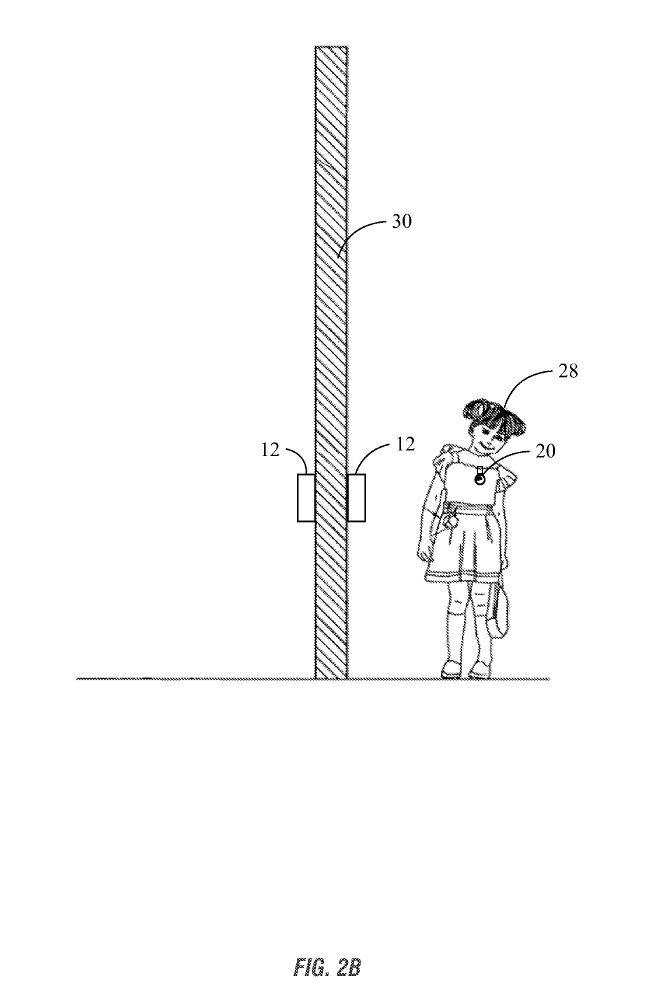

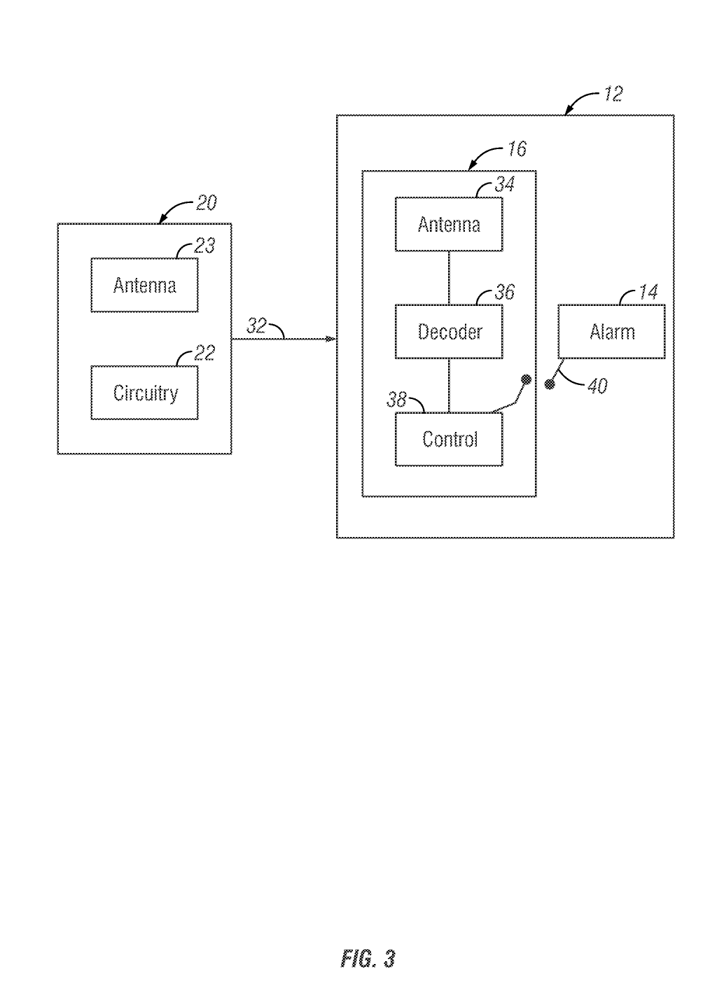

The baby/toddler buzzer system 10 of the present invention comprises an RFID reader/alarm module 12 and a RFID transmitter module 20 (also known as an “RFID tag”), as shown in FIG. 1. A child or toddler 28 wears the RFID tag 20 whenever a parent or guardian cannot physically be in the same room as the child or toddler 28. If or when the child or toddler 28 exits the room to be monitored, the alarm module 12, which is mounted within the doorway 30, will emit a noise alerting the parent or guardian that the child or toddler 28 has exited the room. The set-up of the alarm module 12 at the doorway 30 of a room is shown in FIG. 2A-B.

A schematic of a RFID system used with the present invention is shown in FIG. 3. The RFID transmitter module (also known as an RFID tag) 20 includes a unique identity that emits a signal from a passive RFID circuit 22 containing its identity. The antenna 23 of the RFID tag 20 emits the signal. The signal 32 is a wave that is sent out from the module 20. When the signal 32 is in line with the antenna 34 of the RFID reader 12, located in the circuitry of the RFID reader 12, the reader will decode the signal in its decoder 36 and pass the results to the control unit 38. However, as is stated below, the antenna may search for a signal in an E-plane or H-plane, which may create a threshold through the doorway 30. The specific plane may be designated before fixing the reader 12 to a surface, such that the correct threshold is defined or created. The control unit 38 determines or reads the unique identity of the RFID transmitter 20. The control unit 38 (also known as central control) determines if the alarm 14 should be activated to sound a noise. Therefore, the RFID reader 12 may include a switch 40 or other discretionary connection that allows the control unit 38 to determine when to activate the alarm 14. For instance, if a child 28 wearing an RFID tag 20 passes through the plane or threshold created by the antenna 34, the control unit 38 will activate the alarm 14 to alert a parent or guardian that the child has left the area and that the parent or guardian should stop what he or she is doing to check on the well-being or location of the child.

The RFID reader/alarm module 12 is comprised of a RFID reader circuitry 16 and an alarm device 14, which are housed within an enclosure 18. The reader circuitry 16 employs an antenna 34 that shall be designed such that the E-plane and H-plane only allows communication with transmitter module 20 when module 20 is within the doorway 30. The E-plane and H-plane are reference planes for linearly polarized waveguides, antennas, and other microwave devices. Limiting and shaping the receiving zone of module 12 will stop false positives if the child comes near the doorway 30 but does not enter or exit through doorway 30. In other words, the plane is limited to be perpendicular to a pathway through the door such that the plane is within the doorway. Therefore, the transmitter module 20 would have to pass some distance through the doorway 30 to pass through the plane created by the alarm module 12 for the alarm shown in FIG. 2A to be set off. In the situation shown in FIG. 2B, there would be two planes on each side of the doorway 30, with the alarm going off if either of the planes is crossed by the transmitter module 20. The planes of the alarm module 12 may be designated to emit from the module at virtually 360° from the alarm module 12 to allow for the module 12 to be set within any doorway 30 or other location to allow a parent or guardian to know when the child 28 wearing the transmitter module 20 has passed through the plane or threshold.

The reader/alarm circuitry may be powered by a watch type battery or similarly sized battery to allow for a smaller enclosure 18. The enclosure comprises a rigid material, such as a plastic or metal material. The alarm device 14 may be a piezoelectric buzzer or a speaker. The alarm device 14 may also include a variety of noises and/or other sounds, music or alarms, which may be picked by the parent or guardian, to alert them when the module 20 has passed through a plane of the alarm device 14. It is still further contemplated that the alarm device 14 includes a volume control (not shown) to adjust the volume of the alarm emitting from the device 14.

The RFID reader/alarm module 12 may attached with Velcro®, adhesives, screws, or any other fastening means that allow the alarm module 12 to be affixed to a doorway 30 or wall. The RFID reader/alarm module 12 may also be attached on the doorjamb, as shown in FIG. 2A, or on the trim, as shown in FIG. 2B. It should further be appreciated that the alarm module 12 may be affixed at any arbitrary location on a wall to allow a parent or guardian to know when a child or toddler 28 wearing a transmitter module 20 has passed the arbitrarily designated area.

The transmitter module 20 comprises a passive RFID circuit 22 within a housing 26. The housing 26, as shown in FIG. 1, is a molded plastic disc, which encapsulates the circuit 22. The housing 26 also has a clip 24 which allows module 20 to be attached to the child's clothing or shoes. RFID transmitter module 20 could also be attached using Velcro®, an adhesive, a pin, or a clasp. It is also contemplated by the present invention that the RFID transmitter module 20 may be disposed within a portion of clothing of a child 28 such that the child is unaware of the location of the module 20. A disposable transmitter module 20 such as a “Hello Kitty” sticker or any popular character is also contemplated. The transmitter may also be a wristband.

The baby/toddler buzzer system 10, or invisible fence system, is used as follows. A parent or guardian (not shown), who is in charge of watching a child 28, selects a room or location for the child to play in. At the doorway 30, or doorways, the parent or guardian affixes one or more RFID reader/alarm modules 12. Depending on the orientation of the doorway 30 or module 12, a direction of a plane is chosen to extend the plane across the face of the doorway 30. An RFID transmitter module 20 is affixed to a child 28 within the room enclosed by the RFID reader module 12. The parent or guardian is then free to leave the room as needed. If the child 28 attempts to leave the room, the RFID reader module 12 will read the RFID signal from the transmitter 20 and will emit an alarm to alert the parent or guardian that the child 28 is not where they are supposed to be. The parent or guardian is then able to go to the area of the alarm to safely check on the child 28.

The invention has been shown and described above with the preferred embodiments, and it is understood that many modifications, substitutions, and additions may be made which are within the intended spirit and scope of the invention. The present invention is not to be limited to any specific embodiment described herein.

What is claimed is:

1. A buzzer system for creating an invisible fence for knowing when a child has crossed a threshold, comprising:
a transmitting module positioned on the child, the transmitting module emitting a signal;
an alarm module affixed to a surface, the alarm module configured read the signal of the transmitting module;
the alarm module adapted to emit a noise when the child has crossed the threshold.

2. The buzzer system of claim 1 wherein the alarm module comprises a reader circuitry, an alarm operatively connected to the reader circuitry, and an enclosure for housing the reader circuitry and alarm.

3. The buzzer system of claim 2 wherein the alarm is a piezoelectric buzzer.

4. The buzzer system of claim 1 wherein the surface is a doorway.

5. The buzzer system of claim 1 wherein the surface is a wall.

6. The buzzer system of claim 1 wherein the surface is a trim.

7. The buzzer system of claim 1 wherein the signal is a radio frequency identification (RFID) signal.

8. The buzzer system of claim 7 wherein the alarm module is an RFID reader.

9. The buzzer system of claim 1 wherein the transmitting module is affixed to the child.

10. The buzzer system of claim 1 wherein the alarm module emits a plane from the module, the plane comprising a zone of RFID readability by the alarm module.

11. The buzzer system of claim 10 wherein the plane is emitted at a selected angle from the alarm module.

12. A buzzer system for creating an invisible fence for allowing a guardian to know when a child has crossed a threshold even when the child is out of sight, comprising:
a transmitting module positioned at the child, the transmitting module comprising a circuit configured to emit a signal;
at least one alarm module affixed to a surface, the at least one alarm module comprising a reader circuitry for reading the signal and an alarm operatively connected to the reader circuitry;
the at least one alarm module configured to emit a noise from the alarm when the reader circuitry has read the signal from the transmitting module on the child.

13. The buzzer system of claim 12 wherein the at least one alarm module further comprises an enclosure for housing the reader circuitry and the alarm.

14. The buzzer system of claim 12 wherein the surface is a doorway.

15. The buzzer system of claim 12 wherein the alarm module creates the threshold and the noise is emitted from the alarm when the transmitting module crosses the threshold.

16. The buzzer system of claim 12 wherein the alarm module is affixed to the surface by an adhesive.

17. The buzzer system of claim 12 wherein the signal is an RFID signal.

18. A method of alerting a parent or guardian that a child has crossed a threshold of a room or area, comprising:
creating a threshold by affixing an alarm module to a surface, the alarm module emitting a signal-reading plane therefrom;
positioning a transmitting module on a child, the transmitting module emitting a signal; and
emitting a noise from the alarm module if the transmitting module crosses the threshold created by the plane, the noise alerting the parent or guardian that the child has crossed the threshold.

19. The method of claim 18 further comprising reading the signal emitted by the transmitting module as the transmitting module crosses the plane before emitting the noise from the alarm module.

20. The method of claim 19 further comprising selecting an angle that the signal-reading plane is emitted from the alarm module to create the threshold.
